(19) United States
(12) Patent Application Publication
(10) Pub. No.: US 2024/0313599 A1
(43) Pub. Date: Sep. 19, 2024

(54) ELECTRIC MACHINE DESIGNED AS A SALIENT POLE SYNCHRONOUS MACHINE, COMPONENT FOR AN ELECTRIC MACHINE DESIGNED AS A SALIENT POLE SYNCHRONOUS MACHINE, MOTOR VEHICLE INCLUDING AN ELECTRIC MACHINE, AND METHOD FOR MANUFACTURING A COMPONENT FOR AN ELECTRIC MACHINE DESIGNED AS A SALIENT POLE SYNCHRONOUS MACHINE

(71) Applicant: AUDI AG, Ingolstadt (DE)

(72) Inventor: Vladimir CHERNOGORSKI, Ingolstadt (DE)

(21) Appl. No.: 18/593,461

(22) Filed: Mar. 1, 2024

(30) Foreign Application Priority Data
Mar. 14, 2023 (DE) 102023106333.2

(51) Int. Cl. H02K 3/24; B60K 1/00; H02K 1/24

(52) U.S. Cl. CPC H02K 3/24; H02K 1/24; B60K 1/00

(57) ABSTRACT

An electric machine configured as a salient pole synchronous machine is disclosed and may include at least one component configured as a stator or a rotor and may include a plurality of parts and a cooling system. At least two of the plurality of parts may each have at least one tooth extending along a radial direction of the electric machine and a winding may be wound around each tooth of the at least one tooth. The winding may be formed from one or more electrically conductive conductor wires. The cooling system may be configured such that a cooling fluid may be led through a hollow cross section of at least one of the one or more electrically conductive conductor wires.

### BACKGROUND

### Technical Field

The present disclosure relates to an electric machine designed as a salient pole synchronous machine. The present disclosure further relates to a component for an electric machine designed as a salient pole synchronous machine. Furthermore, the present disclosure relates to a motor vehicle that includes an electric machine. Lastly, the present disclosure relates to a method for manufacturing a component, forming a stator or a rotor, for an electric machine designed as a salient pole synchronous machine.

### Description of the Related Art

With reference to its housing, a salient pole synchronous machine typically includes a fixedly mounted stator and a rotor that is supported such that the rotor is rotatable about a rotational axis. If the salient pole synchronous machine is designed as an internal rotor, the rotor is situated in an area lying farther radially inward than the stator relative to its rotational axis. If the salient pole synchronous machine is designed as an external rotor, the rotor is situated in an area lying farther radially outward than the stator relative to its rotational axis.

Salient pole synchronous machines are synchronous machines that are usually direct current-excited, in which windings are energized to generate the excitation direct current field. In contrast to non-salient pole machines, in which the rotor has longitudinal grooves that accommodate the windings, teeth of the stator or of the rotor which form pole shoes are provided in salient pole synchronous machines, around which the windings are wound. Salient pole synchronous machines are often implemented as internal rotors. In this case, if the salient pole synchronous machine is implemented as an outer pole salient pole machine, the teeth are situated at the stator. For a salient pole synchronous machine implemented as an inner pole salient pole machine, the teeth are situated at the rotor.

The electric current that flows through the conductor wires forming the windings causes the windings to heat. It is therefore necessary to cool the windings, and for this purpose a cooling fluid is led through a rotor shaft or through a rotor core of the rotor, for example. Corresponding systems are known from DE 202012007645U1 or WO 2020/049830A1, for example. However, such cooling concepts, in particular so-called rotor shaft cooling, are disadvantageous because the cooling effect occurs only indirectly. This means that the heat is not directly transferred to the cooling fluid at the heat's point of origin, i.e., in the area of the windings, and instead must initially be transferred from the winding to the rotor shaft or to the rotor core, thus reducing the cooling effect. To counteract this, it is known from the prior art to lead the cooling fluid for the direct cooling of the windings through the conductor wires designed as hollow conductors. Corresponding systems are known from DE 102020114683A1, DE 102013205506A1, DE 102017119033A1, WO 2017/055246A2, WO 2015/150556A1, DE 102013205506A1, or U.S. Pat. No. 3,821,569A, for example.

### BRIEF SUMMARY

The present disclosure provides an electric machine using a conductor wire that forms a winding, and through the hollow cross section of which a cooling fluid may be led.

According to the disclosure, for an electric machine of the type described above, the electric machine may include at least one component that forms either a stator or a rotor and that is assembled from multiple parts. At least two of the parts may each have at least one tooth extending along a radial direction of the electric machine and a winding wound around the same, the winding being formed from one or more electrically conductive conductor wires. The electric machine may have a cooling system by which a cooling fluid may be led through a hollow cross section of the conductor wire or at least one of the multiple conductor wires.

By use of the electric machine, a traction torque may be generatable which may be transferred via a drive train of a motor vehicle to the wheels thereof. The electric machine according to the present disclosure may be designed as an internal rotor in which the component is the rotor, such that the electric machine is an inner pole salient pole machine. In principle, the aspects explained above for salient pole synchronous machines may also be provided for the electric machine according to the present disclosure. The cooling fluid may be a gas, such as air, or may be a cooling liquid, such as water or oil.

In accordance with the present disclosure, it is possible to implement conductor wires, through which cooling fluid flows, for salient pole synchronous machines. Thus, the windings in salient pole synchronous machines may be formed by winding the conductor wire around the tooth, for example using a winding needle. However, this requires sufficient elasticity of the conductor wire, since due to the arrangement of the teeth next to one another, only limited space is available for guiding the winding needle. As a result, the conductor wire may be severely bent during the winding operation, such that conductor wires having hollow cross sections are not suitable for this purpose. Thus, conductor wires with a hollow cross-sectional geometry may have high mechanical rigidity, such that the bendability necessary for the winding using a winding needle is not present.

The component may include a multi-part or multi-piece structure. The multi-part structure may enable the conductor wire to be wound around the tooth, such as by way of the winding needle, before the parts of the component are assembled to form the final stator or rotor. Since the teeth in this state are not yet in their final position relative to one another, a larger tool guiding area, extending around the particular tooth, may be available for the winding needle. After the conductor wires have been wound around the tooth, the parts of the component may be assembled or fastened to one another. Welded, soldered, screwed, riveted connections, and/or intermeshing toothings of the particular parts may be utilized for this purpose. The parts may be made of iron, such as laminated iron, with the assembled parts forming a yoke.

Definitions of relevant spatial directions for the electric machine according to the disclosure are provided below. Thus, a rotor shaft of the rotor is supported such that the rotor shaft is rotatable about a rotational axis that extends along a longitudinal direction of the electric machine. The radial direction extends perpendicularly with respect to the longitudinal direction. In turn, a circumferential direction is perpendicular to the radial direction. That is, a point rotating about the rotational axis moves along the circumferential direction. If one of these directions is mentioned without a specific reference, according to the above definitions it refers to the electric machine. The longitudinal, radial, and circumferential directions with regard to the component correspond to the longitudinal, radial, and circumferential directions of the electric machine.

According to the disclosure, the tooth or at least one section of the tooth may extend along the radial direction. The winding may laterally enclose the particular tooth relative to the radial direction or the longitudinal direction of the tooth. Correspondingly, a longitudinal direction of the conductor wire or of the winding may extend, at least for a portion thereof, perpendicularly with respect to the radial direction.

The conductor wire forming the winding has a hollow cross section. Therefore, the conductor wire has a cooling channel therein which extends along the longitudinal direction of the conductor wire and is laterally closed. The longitudinal direction of the conductor wire and the longitudinal direction of the cooling channel are identical. At each of its ends, i.e., at its end faces, the conductor wire may include an opening which forms an inlet opening or outlet opening, respectively, of the cooling channel. The cooling fluid may be supplied to the conductor wire via one of these openings and discharged via the respective other opening.

The conductor wire is electrically conductive, and thus is made of an electrically conductive material, for example, a metal, such as copper. The outer cross section of the conductor wire may be round, such as elliptical or circular, or rectangular, such as with rounded corners. The same applies for its inner cross section, which forms the outer cross section of the cooling channel.

In the electric machine according to the disclosure, at least one of the parts, in some embodiments each of the parts, may be segmented. With reference to the assembled state of the component, the segmented part, viewed along the longitudinal direction, may be shaped like a piece of pie, i.e., may have two lateral outer sides that are angled with respect to one another and that are in contact with the lateral outer sides of neighboring parts. The opening angle of the circle segment describing the part, i.e., the angle between its lateral outer sides, may be identical for all parts, and may be 60°. In such an embodiment, the component includes six parts which preferably have the identical shape or design. The lateral outer sides may converge on the radially inner side, or may be separated from one another via an internal outer side of the particular part. The lateral outer sides may be separated from one another on the radially outer side via an external outer side of the particular part. The internal outer side and/or the external outer side, viewed along the longitudinal direction, may be curved in a circle.

Additionally or alternatively in the electric machine according to the present disclosure, at least one of the parts, in some embodiments each of the parts, may have exactly one tooth. The tooth, or if the particular part has multiple teeth, the teeth, may be distributed along the circumferential direction at the external outer side. With reference to the assembled state of the component, the teeth may result in a star-like structure in which the teeth are in particular equidistantly arranged along the circumferential direction when viewed in the longitudinal direction. If the opening angle of each of the parts is 60° and each of the parts also has exactly one tooth, the component comprises exactly six teeth. Receiving grooves through which sections of the windings extend are formed between neighboring teeth.

If the component forms the rotor, the parts may be situated along a circumference of a rotor shaft that extends along the longitudinal direction of the electric machine and is rotationally movably supported. The parts may be situated next to one another along the circumferential direction. The internal outer side of the part may be in contact with the rotor shaft and may be fastened thereto. The internal outer side of the part and a radial outer side of the rotor shaft may in each case have toothings that are intermeshed or interlocked with one another. The longitudinal direction of the toothings may extend along the radial directions. A width direction of the toothings, along which the cross sections remain the same, may extend along the longitudinal direction. For mounting along the longitudinal direction, the parts may thus be attached to the rotor shaft. In addition to or as an alternative to the intermeshing, welded soldered screwed, and/or riveted connections may be provided for fastening the parts to the rotor shaft.

The rotor shaft may be connected to the housing via at least one bearing, which may be a ball bearing or a roller bearing. The rotor shaft may be coupled to an input shaft and/or output shaft of the electric machine or may form the same. Correspondingly, a torque is transferable from the rotor shaft to the drive train of the motor vehicle, and/or vice versa, in particular via the input shaft and/or output shaft.

The teeth each may have a T shape with a longitudinal bar and a transverse bar, the longitudinal bar extending along the radial direction and the conductor wire being wound around the longitudinal bar. With reference to the mounted state, the longitudinal direction of the longitudinal bar extends along the radial direction, and the longitudinal direction of the transverse bar extends along the circumferential direction. The transverse bar may be curved on the radially outer side, such that an air gap, which may have a constant width, is formed between this outer face of the tooth and the stator or rotor. The tooth may implement a pole shoe which results in a desired field shape, such as sinusoidal, of the magnetic field generated by way of the winding, toward the air gap.

According to the present disclosure, the winding may be formed from exactly one conductor wire that is continuous, i.e., uninterrupted with regard to its longitudinal direction. At least one of the windings may have multiple winding layer groups situated one on top of the other relative to the radial direction. Each of the winding layer groups may include a winding layer or multiple winding layers situated one on top of the other, the winding layer groups each being formed from a separate conductor wire. In this embodiment, the winding includes multiple conductor wires, and these conductor wires or the winding layer groups may be electrically connected in series relative to one another.

Each of the winding layers may extend along the entire circumference of the particular tooth or completely encloses the same laterally. The winding layer includes at least one winding turn of the conductor wire, which encloses or encircles the tooth by 360° or exactly one time. If the winding layer has multiple winding turns, it may have a helical structure, viewed in the radial direction, that is perpendicular to the radial direction. Within a winding layer, the winding turns are situated concentrically around the particular tooth.

The conductor wire that forms a winding layer group may have an input-side end section and/or an output-side end section. The end sections may include the end face-side ends or end faces of the particular conductor wire, such that the inlet opening of the cooling channel is situated in the region of the input-side end section, and/or the outlet opening of the cooling channel is situated in the region of the output-side end section. The input-side end section and/or the output-side end section may protrude laterally from this winding, relative to the longitudinal direction of the particular tooth or the particular winding, to facilitate or enable fluidic and/or electrical contacting of this winding.

The electric machine according to the present disclosure may have at least one fluidic input connection component which may fluidly connect input-side end sections of the conductor wires of at least two winding layer groups to one or more feed chambers, which may be fluidically connected upstream from these conductor wires, such that these winding layer groups are fluidically connected in parallel. The cooling fluid flowing through the feed chamber may be divided at the fluidic input connection component into multiple substreams that are supplied to different winding layer groups. The substreams in each case flow do not flow through the complete winding, but, rather, flow only through a portion thereof, namely, the particular winding layer group, thus increasing the cooling effect. The fluidic input connection component may be made of a plastic or a metal.

In some embodiments, the electric machine according to the present disclosure may have at least one fluidic output connection component which may fluidly connect output-side end sections of the conductor wires of at least two winding layer groups to one or more discharge chambers, which may be connected downstream from these conductor wires. After flowing through the particular winding layer group, the cooling fluid may be supplied to the discharge chamber via the output-side end section and the fluidic output connection component. The substreams flowing through the particular winding layer groups combine in the respective fluidic output connection component. The fluidic output connection component may be made of a plastic or a metal.

The electric machine according to the present disclosure may have one or more supply parts which may be situated next to at least one of the windings, relative to a longitudinal direction of the electric machine. At least one of the supply parts may be configured as a feed part and having at least one of the feed chambers, or at least one of the supply parts being configured as a discharge part and having least one of the discharge chambers. The supply part may be a component that is made of a metal or a plastic. The fluidic input connection component and/or the fluidic output connection component may be fastened to the supply part, such as by forming a detent connection. In some embodiments, the supply part may have at least one receiving opening that opens into the feed chamber or the discharge chamber, respectively, and the connection component may be inserted into the receiving opening. Both the feed part and the discharge part may be provided with the respective winding being situated therebetween, relative to the longitudinal direction.

In some embodiments, the supply part or at least one of the multiple supply parts may have an annular shape and may be concentrically situated around a rotor shaft, the component forming the rotor, which extends along the longitudinal direction and is rotationally movably supported, the feed chamber or at least one of the multiple feed chambers, and/or the discharge chamber or at least one of the multiple discharge chambers having an annular shape and being concentrically situated around the rotor shaft. The supply part may be fastened to the component, such as to the rotor shaft and/or to the teeth. In some embodiments, the feed chamber may be fluidically connected upstream from all winding layer groups of all windings and/or the discharge chamber may be fluidically connected downstream from all winding layer groups of all windings.

The electric machine may have one or more electrical connection components, which connect end sections of the conductor wires of two neighboring winding layer groups of one of the windings to one another, such that these winding layer groups are electrically connected in series. Although the winding in such embodiments may have multiple conductor wires, instead of one continuous conductor wire, the conductor wires of the winding layer groups connected by the electrical connection component may form an electromagnetic field coil due to their electrical connection in series. In manufacturing of the winding, it is not necessary to wind a single, continuous or uninterrupted piece of conductor wire around the tooth, and instead, shorter pieces of conductor wire may be appropriately positioned. The advantages of the present disclosure explained above in conjunction with the manufacture of the electric machine are thus even further enhanced. The electrical connection component may be made of an electrically conductive material, for example, a metal, such as copper. The electrical connection component may be made of an electrically insulating material such as a plastic and may have an electrically conductive connection element which achieves the electrical contacting of the particular end sections.

In some embodiments, the end sections of the conductor wires of all winding layer groups, neighboring pairs, the particular winding may be connected to one another via an electrical connection component, such that all winding layer groups of the particular winding are successively electrically connected in series.

In some embodiments, at least one shared connection component may form both the fluidic connection component or one of the multiple fluidic connection components and the electrical connection component or one of the multiple electrical connection components. In such embodiments, the shared connection component may be provided as a shared part, which, on the one hand, implements the electrical connection component or one of the electrical connection components, and, on the other hand, implements the fluidic connection component or one of the fluidic connection components.

The at least one shared connection component may include a base body made of an electrically conductive material, which may be a metal such as copper. The base body may include at least one channel and/or at least one chamber through which the cooling fluid may be led. The channel or the chamber may be fluidically situated between the feed chamber or the discharge chamber and the respective conductor wire. The respective end sections may be in physical contact with the electrically conductive base body, such that the electrical contacting is achieved via the base body.

With regard to the cooling system, the cooling system may form a cooling circuit in which the cooling fluid is conveyable via a conveying means or device. In such embodiments, the cooling fluid may circulate from the conveying means or device to the windings and back, and is thus appropriately circulated. The conveying means or device may be a cooling fluid pump. A cooling device for cooling the cooling fluid, such as a heat exchanger, may be incorporated into the cooling system.

The rotor shaft of the component which forms the rotor, and which is rotationally movably supported and extends along a longitudinal direction of the electric machine, may have or border at least one feed channel and/or at least one discharge channel, and the feed channel and/or the discharge channel may extend, at least in sections, along the longitudinal direction of the rotor shaft. The feed channel may lead from the conveying means or device to the conductor wire or at least one of the multiple conductor wires having the hollow cross section. The discharge channel may lead to the conveying means or device from the conductor wire or at least one of the multiple conductor wires having the hollow cross section. The feed channel and/or the discharge channel may be designed as a central, longitudinal borehole in the rotor shaft. The feed channel and/or the discharge channel may have a hollow cylindrical or sleeve-like geometry, and may extend between the rotor shaft and a rotatably fixed, rotor shaft sleeve in which the rotor shaft is situated or supported.

The cooling circuit may include a movable section and a stationary section. In the movable section, the cooling fluid may be led through rotating parts of the electric machine, such as through the rotor. In the stationary section, the cooling fluid may be led through stationary parts of the electric machine, such as through the conveying means or device. For the transfer of the cooling fluid from the stationary section into the movable section, the cooling fluid may be introduced into the feed channel by way of a feed lance. For the transfer of the cooling fluid from the movable section into the stationary section, the cooling fluid may flow across at least one transverse borehole and/or lateral opening in the rotor shaft.

The present disclosure further relates to a component for an electric machine designed as a salient pole synchronous machine, in which the component forms either a stator or a rotor and is assembled from multiple parts. At least two of the parts may have at least one tooth extending along a radial direction of the electric machine and a winding wound around the same. The winding may be formed from one or more electrically conductive conductor wires, and the cooling fluid may be leadable through a hollow cross section of the conductor wire or at least one of the multiple conductor wires. All advantages and features explained in conjunction with the electric machine according to the present disclosure are likewise transferable to the component according to the present disclosure, and vice versa.

The present disclosure further relates to a motor vehicle that includes an electric machine according to the above description. All advantages and features explained in conjunction with the electric machine according to the present disclosure and the component according to the present disclosure are likewise transferable to the motor vehicle according to the present disclosure, and vice versa.

The electric machine may be connected to a drive train of the motor vehicle or may be a component of the same, such that a torque is transferable from the electric machine to wheels of the motor vehicle and/or vice versa. Specifically, the rotor or a rotor shaft of the rotor, which forms an input shaft and/or output shaft of the electric machine, may be coupled to a drive train of the motor vehicle, such that a rotation of the rotor or of the rotor shaft is transferred to components of the drive train and vice versa. In addition to a drive shaft and the wheels, the drive train may include further components that enable torque transfer between the electric machine and the wheels of the motor vehicle, for example a transmission, a clutch, and/or a differential or the like. Details in this regard are well known to those skilled in the art, and are not explained in greater detail here.

The electric machine may be operable in a drive mode in which it generates a traction torque for driving the motor vehicle. In this mode, the electrical energy stored in an electrical energy store of the motor vehicle is converted into kinetic energy of the motor vehicle by way of the electric machine. The accelerating or positive torque generated by the electric machine is transferred to the drive train and thus to the wheels. Specifically, the windings are electrically energized by way of the energy stored in the electrical energy store, which is the result of magnetic fields induced by the windings. These magnetic fields interact with magnetic fields of further coils or permanent magnets of the electric machine in such a way that positive torque is generated.

The electric machine may be operable in a recuperation mode in which a deceleration torque for decelerating the motor vehicle is generated. In this mode, the electric machine converts the kinetic energy of the motor vehicle into electrical energy, which is storable in the electrical energy store of the motor vehicle and/or usable for operating electrical units of the motor vehicle. For this purpose, the decelerating or negative torque present at the rotor is transferred to the drive train, and via the drive train to the wheels. Specifically, the magnetic fields of further coils or permanent magnets bring about induction of an electrical current into the windings, the corresponding electromagnetic interaction producing the negative torque, and the current induced in the windings being usable, for example, for charging the electrical energy store.

Lastly, the present disclosure relates to a method for manufacturing a component, such as forming a stator or a rotor, for an electric machine designed as a salient pole synchronous machine, the component being assembled from multiple parts. At least two of the parts may each have at least one tooth extending along a radial direction of the electric machine, around which at least one electrically conductive conductor wire for forming a winding is wound before the parts are assembled. A cooling fluid of a cooling system of the electric machine may be leadable through a hollow cross section of at least one of the at least one conductor wires. All advantages and features explained in conjunction with the electric machine according to the present disclosure, the component according to the present disclosure, and the motor vehicle according to the present disclosure are likewise transferable to the method according to the present disclosure, and vice versa.

### BRIEF DESCRIPTION OF THE SEVERAL VIEWS OF THE DRAWINGS

FIG. 1 shows a schematic diagram of a motor vehicle including an electric machine with a component.

FIG. 2 shows a longitudinal section through the electric machine of the motor vehicle in FIG. 1.

FIG. 3 shows an enlarged illustration of a cross section of the electric machine of the motor vehicle in FIG. 1.

FIG. 4 shows an enlarged illustration of an area of the longitudinal section illustrated in box IV of FIG. 2.

FIG. 5 shows a front view of one of the windings of the component of the electric machine in FIG. 2.

FIG. 6 shows a perspective view of one of the windings of the component of the electric machine in FIG. 2.

FIG. 7 shows a top view of one of the windings of the component of the electric machine in FIG. 2.

FIG. 8 shows a longitudinal section through the electric machine of the motor vehicle in FIG. 1.

FIG. 9 shows a schematic diagram of one of the windings of the electric machine in FIG. 2.

FIG. 10 shows an enlarged illustration of box X of the illustration in FIG. 6.

### DETAILED DESCRIPTION

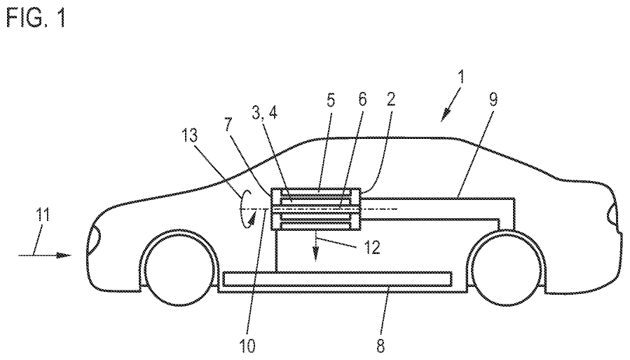

FIG. 1 shows a motor vehicle 1 according to the present disclosure according to one exemplary embodiment, including an electric machine according to the present disclosure according to one exemplary embodiment. The electric machine 2 includes a component 3 according to the present disclosure according to one exemplary embodiment, which in the present embodiment is a rotor 4 of the electric machine 2. In addition, the electric machine 2 includes a stator 5.

The electric machine 2 may be a salient pole synchronous machine, which by way of example, is configured as an internal rotor. The rotor 4 may be situated in an area of the electric machine 2 lying farther radially inward than an area in which the stator 5 is situated. A rotor shaft 6 of the rotor 4 may be rotatably supported at a housing 7 of the electric machine 2, for example, by way of a ball bearing or roller bearing. The rotor shaft 6 may be situated in a fixedly mounted rotor shaft sleeve 58, which is discussed in greater detail below.

The electric machine 2 may be configured to be operated in a drive mode in which electrical energy that is stored in an electrical energy store 8 of the motor vehicle 1 is converted into kinetic energy of the motor vehicle 1. A generated drive torque that is utilized to propel the motor vehicle 1 may be transferable from the electric machine 2 to a drive train 9 of the motor vehicle 1. The drive torque may be transferable only to the rear wheels, but additionally or alternatively may also be transferable to the front wheels. The electric machine 2 may also be operable in a recuperation mode in which the electric machine 2 converts kinetic energy of the motor vehicle 1 into electrical energy which is usable, for example, for charging the electrical energy store 8.

Definitions of relevant spatial directions with regard to the electric machine 2 are provided below. The rotor shaft 6 is supported so as to be rotatable about a rotational axis 10 that extends along a longitudinal direction 11 of the electric machine 2. A radial direction 12 extends perpendicularly with respect to the longitudinal direction 11. A circumferential direction 13 is perpendicular to the radial direction 12. That is, a point rotating about the rotational axis 10 moves along the circumferential direction 13.

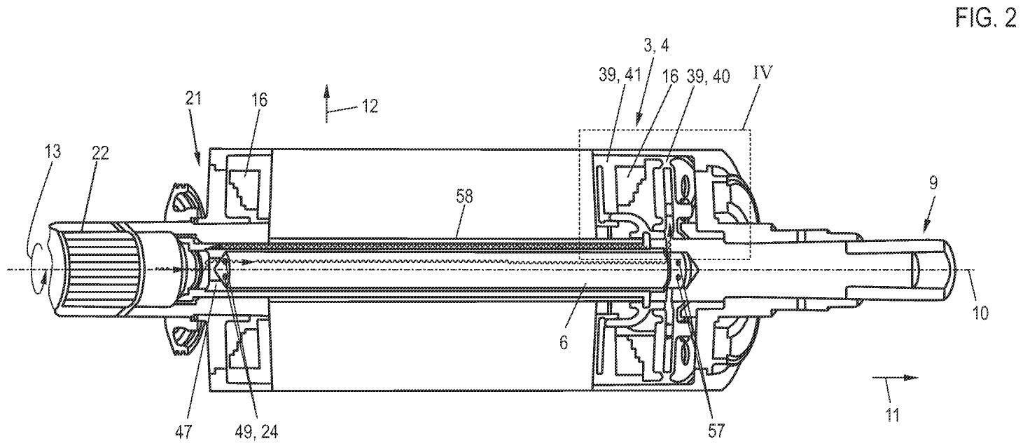

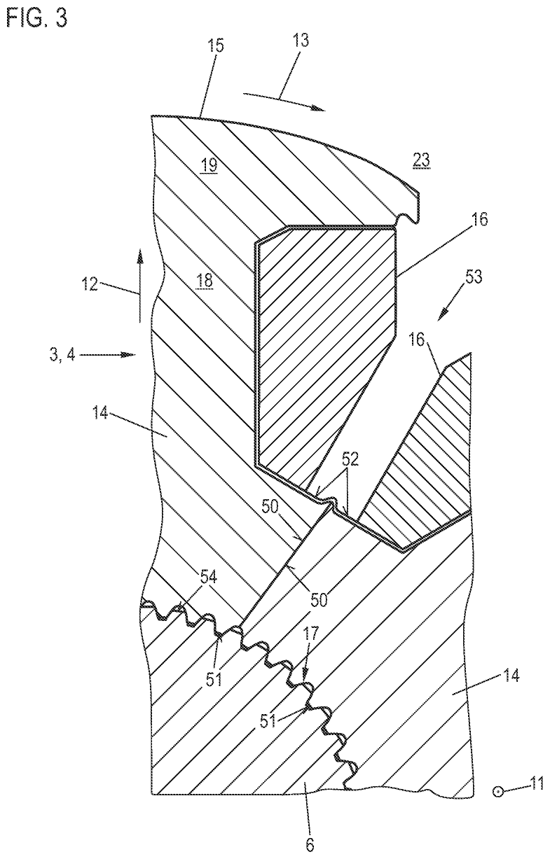

Details regarding the component 3 or the rotor 4 are explained below with reference to FIGS. 2 and 3. FIG. 2 shows a sectional view of the component 3, with the section plane extending along the rotational axis 10. FIG. 3 shows a sectional view of the component 3, with the section plane perpendicular to the rotational axis 10. With reference to FIG. 3, it is apparent that the component 3, i.e., the rotor 4, comprises multiple parts 14. Each of the parts 14 includes a tooth 15, extending along the radial direction 12, around which a winding 16 is wound. The component 3 is manufactured according to one exemplary embodiment of a method according to the present disclosure. For this purpose, it is provided that the component 3 is assembled from the multiple parts 14, with conductor wires 20 of the windings 16 previously having been wound around the particular tooth 15.

Details concerning the geometry of the parts 14 are explained below. As an example, exactly one tooth 15 may be provided for each part 14. Each of the total of six parts 14 may be segmented. A total of six teeth 15, which may form a star-like structure, are provided along the circumferential direction 13. Receiving grooves 53, in which the windings 16 are situated or through which the windings 16 extend, may be formed between neighboring teeth 15.

The segmented parts 14 may each have two lateral outer sides 50 that are angled with respect to one another and that are in contact with the lateral outer sides 50 of neighboring parts 14. The opening angle between the lateral outer sides 50 may be identical for all parts, and may be 60°. The lateral outer sides 50 may converge on the radially inner side, or as in the present exemplary embodiment, may be separated from one another via an internal outer side 51 of the particular part 14. The internal outer side 51, viewed along the longitudinal direction 11, may be curved in a circle. The lateral outer sides 50 on the radially outer side may be separated from one another via an external outer side 52 of the particular part 14, the tooth 15 being situated at the external outer side 52. Thus, the lateral outer sides 50, which are angled with respect to one another, may be spaced apart, with the internal outer side 51 and the external outer side 52 extending therebetween. The external outer side 52 in each case may represent a portion of a base of one of the receiving grooves 53.

The parts 14 may be situated next to one another at the rotor shaft 6 along the circumferential direction 13. The internal outer side 51 of the particular part 14 may be in physical contact with the rotor shaft 6 and may be fastened thereto. Specifically, the internal outer side 51 of the particular part 14 and a radial outer side 54 of the rotor shaft 6 may each have a toothing 17, with the toothings 17 intermeshing. Additionally or alternatively, a welded, soldered, screwed, and/or riveted connection may be provided for fastening the parts 14 to the rotor shaft.

The teeth 15 may each have a T shape with a longitudinal bar 18 and a transverse bar 19, the longitudinal direction of the longitudinal bar 18 extending along the radial direction 12, and the longitudinal direction of the transverse bar 19 extending along the circumferential direction 13. The winding 16 may be wound around the longitudinal bar 18. The transverse bar 19 may be bent on the radially outer side, forming an air gap 23 a few millimeters wide between the tooth 15 forming a pole shoe and the stator 5, which is not shown in FIG. 3.

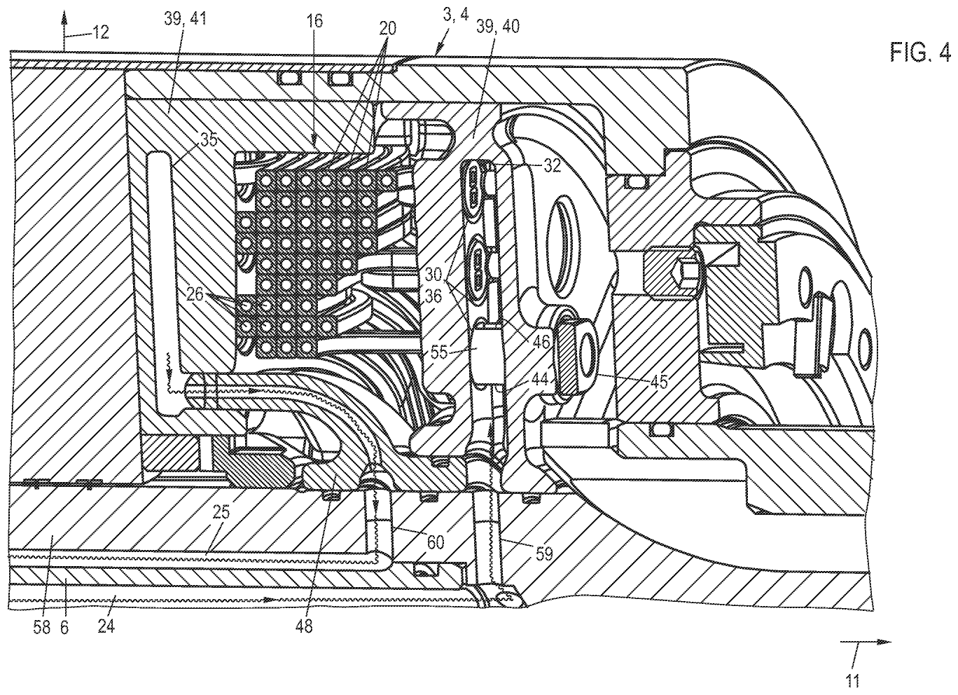

Details concerning the windings 16 are explained below with reference to FIG. 4, which represents an enlarged illustration of the box marked with reference symbol IV in FIG. 2. Each of the windings 16 is formed from electrically conductive conductor wires 20, which each have hollow cross sections forming a cooling channel 26 through which a cooling fluid may be led. The cooling fluid in the present case is a cooling liquid by way of example, namely, water or oil. The conductor wires 20 may each be made of a metal, namely, copper. The outer cross section of the conductor wire 20 may be rectangular as an example, and may have rounded corners. In some embodiments, the outer cross section may be round, such as elliptical or circular. The inner cross section of the conductor wire 20, i.e., an outer cross section of the cooling channel 26 formed by the particular conductor wire 20, may be circular. However, this inner cross section may also be elliptical or rectangular, and may have rounded corners.

Each of the conductor wires 20 has one of the cooling channels 26, which extends along the longitudinal direction of the particular conductor wire 20 and is laterally closed. Solely at its front or end-side ends, i.e., at its end faces, each of the conductor wires 20 may have an opening which respectively may form an inlet opening or outlet opening of the cooling channel 26. The cooling fluid may be supplied to the conductor wire 20 or cooling channel 26 via one of these openings, and may be discharged from the conductor wire 20 or cooling channel 26 via the respective other opening.

In addition, the electric machine 2 has a cooling system 21 (see FIG. 2) which forms a cooling circuit in which the cooling fluid may be conveyable by way of a conveying means or device 22, which in the example embodiment of FIG. 2 is a cooling fluid pump. The cooling circuit or a portion of the path taken by the cooling fluid when flowing through the cooling circuit is indicated by wavy arrows in the figures. For leading the cooling fluid, the rotor shaft 6 may include a feed channel 24 which extends along the longitudinal direction 11, and which may be a central or longitudinal borchole in the rotor shaft 6, and may include a discharge channel 25 extending in parallel thereto. Further details concerning the channels 24, 25 are explained in greater detail below.

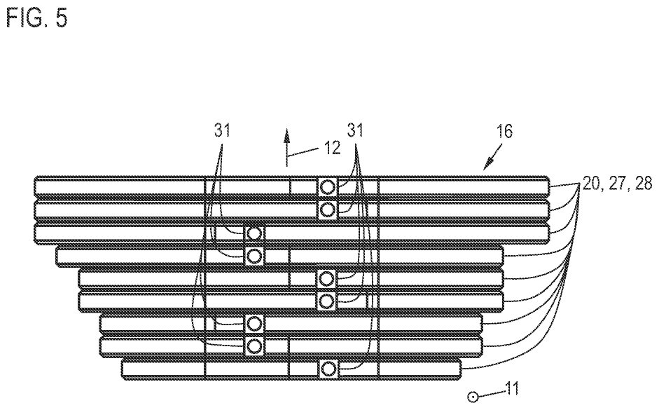

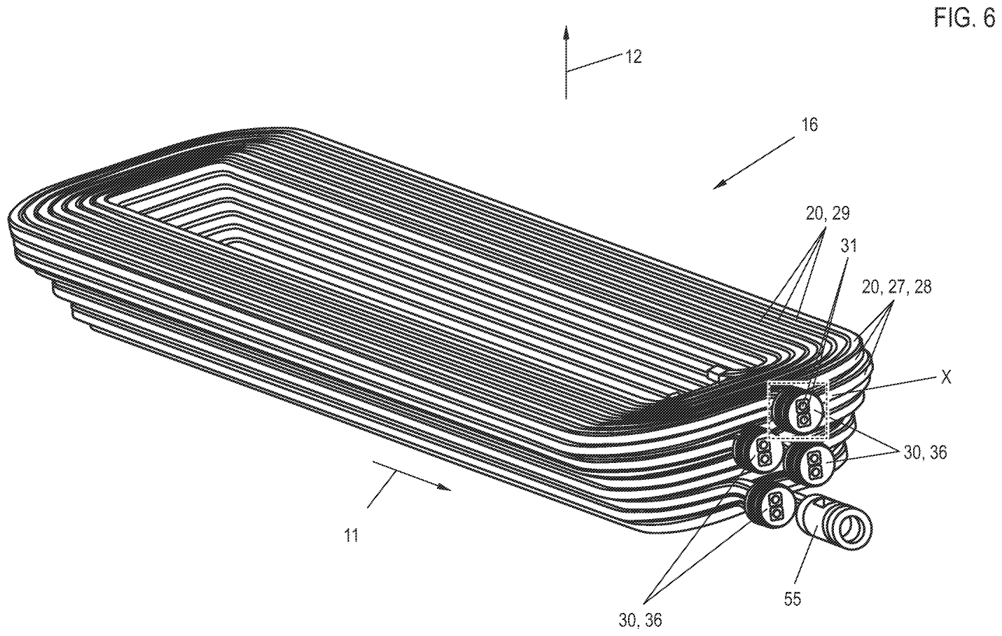

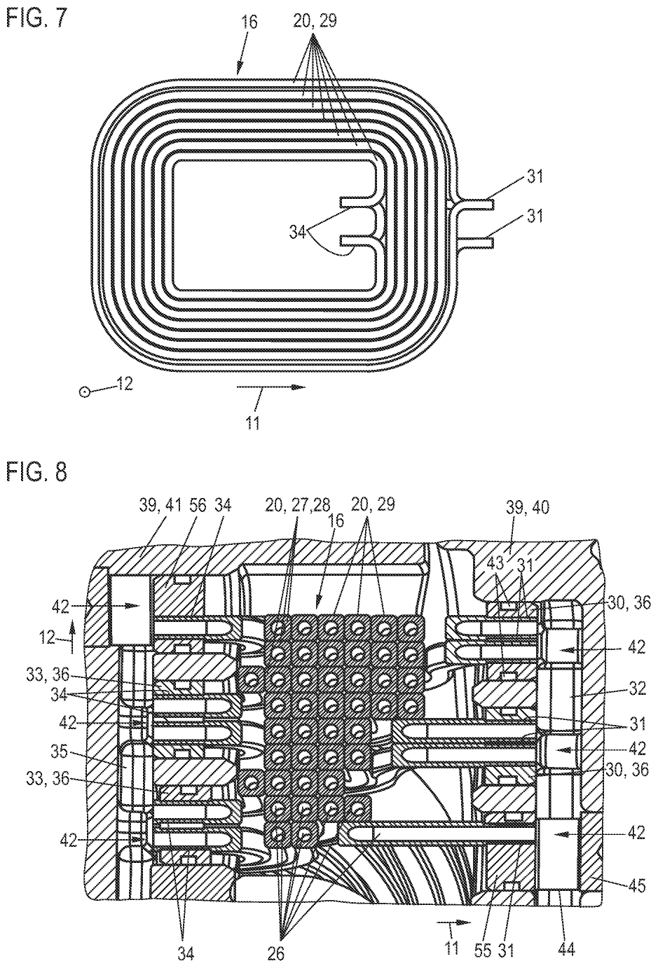

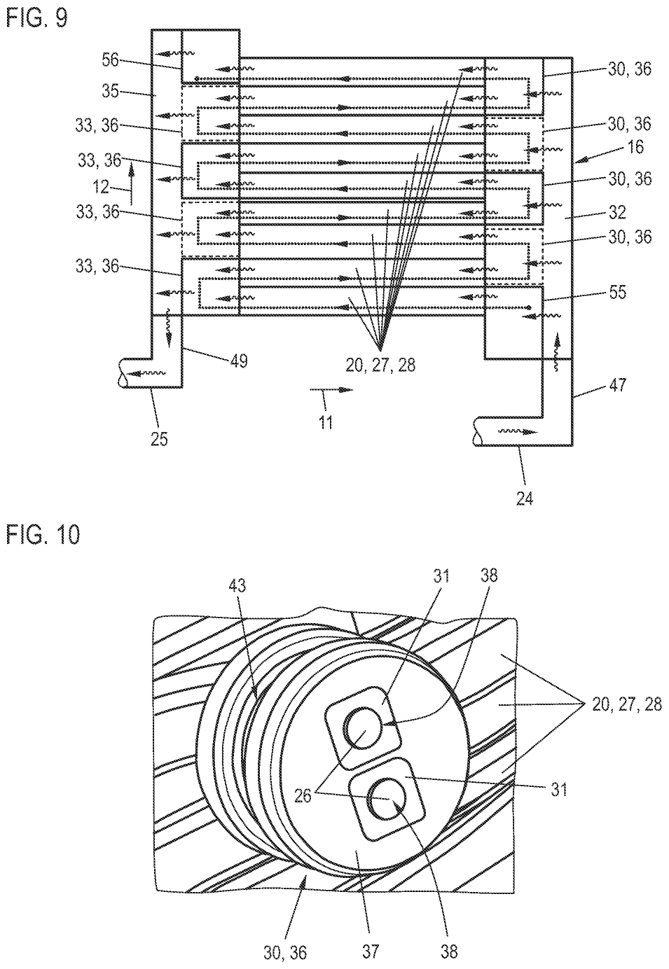

Details concerning the design of the winding 16 are explained below with reference to FIGS. 5 through 9. FIGS. 5 through 7 show different schematic views of one of the windings 16, with further parts of the component 3 being omitted for better clarity. FIG. 5 shows the winding 16 in a front view with the viewing direction along the longitudinal direction 11. FIG. 6 shows the winding 16 in a perspective view. FIG. 7 shows the winding 16 in a top view with the viewing direction along the radial direction 12. FIG. 8 shows an illustration similar to FIG. 4, with the region of the winding 16 being depicted in enlarged scale and the section plane rotated by an angle about the rotational axis 10 in such a way that the rotational axis extends centrally through connection components 30, 33, 36, which are explained in greater detail below. FIG. 9 shows a schematic illustration of FIG. 8.

As shown in FIGS. 5 through 9, the winding 16 may have multiple winding layer groups 27 situated one on top of the other relative to the radial direction 12, with each of the winding layer groups 27 including one winding layer 28 by way of example. Alternatively, at least one of the winding layer groups 27 may have multiple winding layers 28 situated one on top of the other relative to the radial direction 12. In the example embodiments shown in FIGS. 5 through 9, each of the winding layers 28 includes multiple winding turns 29 that form a spiral structure, with the conductor wire 20 extending completely around the tooth 15 exactly one time within a winding turn 29. A total of nine winding layer groups 27 may be provided.

With regard to the winding layer groups 27, it is provided that the one-piece conductor wire 20 that forms the particular winding layer group 27 has an input-side end section 31 and an output-side end section 34. The end sections 31, 34 include the end face-side ends or end faces of the particular conductor wire 20, where an inlet opening or outlet opening of the cooling channel 26 of the particular conductor wire 20 is respectively situated. As shown in FIGS. 7 and 8, the end sections 31, 34 may protrude laterally from the winding 16, along the longitudinal direction 11.

As shown in FIGS. 8 and 9, multiple fluidic input connection components 30 may be provided, which may be configured to connect the input-side end sections 31 of two neighboring winding layer groups 27 to a feed chamber 32 that is fluidically connected upstream, such that these winding layer groups 27 are fluidically connected in parallel. A total of four fluidic input connection components 30 may be offset relative to one another along the radial direction 12, as shown in FIG. 5. Due to the position of the section plane, only some of the fluidic input connection components 30 are discernible in FIGS. 8 and 9, and in FIG. 9 the non-visible fluidic input connection components 30 are indicated by dashed lines. As shown in FIG. 9, relative to the radial direction 12 to the outside, the second and the third, the fourth and the fifth, the sixth and the seventh, and the eighth and the ninth winding layer group 27 may each be respectively connected to one of the fluidic input connection components 30.

In addition, multiple fluidic output connection components 33 may be provided, which may be configured to fluidly connect the output-side end sections 34 of two neighboring winding layer groups 27 to a discharge chamber 35, which is fluidically connected downstream from the same. A total of four fluidic output connection components 33 may be provided which, similarly as for the fluidic input connection components 30, may be offset relative to one another along the radial direction 12. The fluidic input connection components 33 not visible in FIG. 9 are indicated by dashed lines. Relative to the radial direction 12 to the outside, the first and the second, the third and the fourth, the fifth and the sixth, and the seventh and the eighth winding layer group 27 may each be respectively connected to one of the fluidic output connection components 33.

The fluidic connection components 30, 33 may be fluidically connected upstream or downstream, respectively, from a neighboring pair of winding layer groups 27. The cooling fluid stream flowing through the feed chamber 32 may be divided over the two downstream winding layer groups 27 by way of the fluidic input connection components 30, wherein the resulting substreams flowing in parallel through the winding layer groups 27 pass through the fluidic output connection components 33 and into the discharge chamber 35, where they are recombined.

For the electrical contacting of the winding layer groups 27, electrical connection components 36 may connect the end sections 31, 34 of two neighboring winding layer groups 27 to one another, such that these winding layer groups 27 are electrically connected in series. Specifically, the end sections 31, 34 of the conductor wires 20 of all pairwise neighboring winding layer groups 27 of the winding 16 may be connected to one another via an electrical connection component 36, such that all winding layer groups 27 of the particular winding 16 are successively electrically connected in series. The routing of the electrical current is indicated by dotted arrows in FIG. 9.

A portion of the electrical connection components 36, may form the fluidic input connection components 30, and another portion thereof may form the fluidic output connection components 33. Each electrical connection component 36 thus forms a fluidic connection component 30, 33 and vice versa, such that in such embodiments, a shared connection component 30, 33, 36 is implemented in each case. Thus, in such embodiments, at least one of the electrical connection components 36 may form one of the fluidic input connection components 30 or one of the fluidic output connection components 36, such that these two components are a single part.

FIG. 10 shows a perspective, enlarged view of one of the shared connection components 30, 33, 36. Specifically, the topmost of the connection component 30, 33, 36 illustrated in FIG. 6, is shown, with the illustration area in FIG. 10 being marked in FIG. 6 by a box X. Accordingly, the connection components 30, 33, 36 each include a base body 37 made of an electrically conductive material, namely, a metal such as copper. The necessary electrical contacting between the respective neighboring winding layer groups 27 may be achieved in this way. The base body 37 may include two channels 38 which in each case form a connection interface, and through which the cooling fluid may be led. The respective end sections 31, 34 may be introduced into the channels 38 or plugged in fluid-tight, thus also establishing the electrical contacting. The inner cross section of the channels 38 may correspond to the outer cross section of the end section 31, 34 inserted therein. Instead of the channels 38, the base body 37 may have at least one chamber for leading the cooling fluid.

With reference to FIGS. 4, 8, and 9, an input connection component 55 and an output connection component 56 are provided, which apart from the aspects explained below correspond to the connection components 30, 33, 36. With reference in particular to FIGS. 4 and 8, the input connection component 55 may have a longitudinal section 44 that extends through the feed chamber 32, such that an electrical contacting head 45, via which the electrical contacting from the outside with the respective winding 16 may be provided, is externally situated at a feed part 40, which is explained in greater detail below. A slotted opening 46 through which the cooling fluid flows from the feed chamber 32 into the respective end section 31 may be laterally provided at the longitudinal section 44. In addition, the output connection component 56 may have a longitudinal section 44 which extends through the discharge chamber 35, such that an electrical contacting head 45, via which the electrical contacting from the outside with the respective winding 16 may be provided, is externally situated at a discharge part 41, which is explained in greater detail below. A slotted opening 46 through which the cooling fluid flows from the respective end section 34 into the discharge chamber 35 may be laterally provided at the longitudinal section 44.

Details concerning the implementation of the feed chamber 32 and the discharge chamber 35 are explained below with reference to FIGS. 4 and 8. Supply parts 39 may be arranged next to the winding 16, relative to the longitudinal direction 11, such that the winding 16 is situated between the supply parts 39. One of the supply parts 39 is the feed part 40, which has the feed chamber 32. The other of the supply parts 39 is the discharge part 41, which has the discharge chamber 35. The supply parts 39 may each be made of a plastic and may have an annular shape that extends concentrically around the rotor shaft 6. Correspondingly, the feed chamber 32 and the discharge chamber 35 may also have an annular shape and may be situated concentrically around the rotor shaft. The feed chamber 32 and the discharge chamber 35 may form a shared chamber that is fluidically connected, upstream or downstream, respectively, to all end sections 31, 34 of all windings 16.

As shown in FIG. 8, the supply parts 39 may each have receiving openings 42 that open into the feed chamber 32 or the discharge chamber 35. The receiving openings 42 may be generally cylindrical, and may be adapted to the shape of the connection components 30, 33, 36 and the components 55, 56. The connection components 30, 33, 36 and the components 55, 56 may be fastened to the supply part 39 by inserting them, respectively, into one of the receiving openings 42. The receiving openings 42 and the connection components 30, 33, 36 as well as the components 55, 56 may have detent devices or means 43 for fastening these components to one another. As detent devices or means 43, locking grooves of the connection components 30, 33, 36 and of the components 55, 56 may be provided, into which locking tabs of the receiving openings 42 or of the particular supply part 39 engage.

Details concerning the specific routing of the cooling fluid in the cooling system 21 are now explained with reference to FIGS. 2 and 4. After the cooling fluid has passed through the conveying means or device 22, it may be introduced into an introduction chamber 47, which may be situated on the end-face side of the rotor shaft 6, via a feed lance, not shown in the figures. The cooling fluid may flow through the introduction chamber 47 and into the feed channel 24 via openings 49 on the end-face side of the rotor shaft 6 which may be situated at the end thereof on the conveying device side. After the cooling fluid has flowed through the feed channel 24 and reaches an end of the rotor shaft 6 on the winding side, it may exit the rotor shaft 6 via lateral openings 57 in the rotor shaft, which may be due to the centrifugal force that is created by the rotation of the rotor shaft 6. The cooling fluid may subsequently pass into the feed chamber 32 through first transverse boreholes 59 in the rotor shaft sleeve 58. The cooling fluid may subsequently flow through the winding 16 according to the above description and may then pass into the discharge chamber 35. From there it may be led, due to the subsequently arriving cooling fluid, into a cooling fluid channel of a connecting part 48 that opens into second transverse boreholes 60 in the rotor shaft sleeve 58. The second transverse boreholes 60 may open into the discharge channel 25. The discharge channel may have a hollow cylindrical or sleeve-like geometry, and may extend between the rotor shaft 6 and the rotor shaft sleeve 58 along the longitudinal direction 11, such that the cooling fluid flows back to the end of the rotor shaft 6 on the conveying device side, where it is supplied to the conveying means or device 22.

Although the component 3 according to the present disclosure forms the rotor 4 of the electric machine 2 in the explained exemplary embodiment, within the scope of the present disclosure it is likewise conceivable for the stator 5 to implement the component 3 and the aspects thus explained. In such embodiments, the teeth 15, the windings 16, and the aspects thus explained are implemented by the stator 5.

German patent application no. 102023106333.2, filed Mar. 14, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An electric machine configured as a salient pole synchronous machine, comprising:
at least one component configured as a stator or a rotor, the at least one component comprising:
a plurality of parts, wherein at least two parts of the plurality of parts each have at least one tooth extending along a radial direction of the electric machine; and
a winding wound around each tooth of the at least one tooth, the winding being formed from one or more electrically conductive conductor wires; and
a cooling system configured such that a cooling fluid is led through a hollow cross section of at least one of the one or more electrically conductive conductor wires.

2. The electric machine according to claim 1, wherein each of the plurality of parts is segmented and includes exactly one tooth.

3. The electric machine according to claim 1, wherein the at least one component is configured as a rotor, and the plurality of parts of the at least one component are situated along a circumference of a rotor shaft, the rotor shaft extending along a longitudinal direction of the electric machine and being rotationally movably supported.

4. The electric machine according to claim 1, wherein each of the teeth have a T-shape including a longitudinal bar and a transverse bar, the longitudinal bar extending along the radial direction and the one or more electrically conductive conductor wires being wound around the longitudinal bar.

5. The electric machine according to claim 1, wherein at least one of the windings includes a plurality of winding layer groups situated one on top of another relative to the radial direction, each of the plurality of winding layer groups including a winding layer or a plurality of winding layers situated one on top of another, the plurality of winding layer groups each comprising a separate electrically conductive conductor wire.

6. The electric machine according to claim 5, further comprising at least one fluidic input connection component configured to fluidly couple input-side end sections of electrically conductive conductor wires of at least two winding layer groups to one or more feed chambers,
wherein the one or more feed chambers are fluidly coupled upstream from the electrically conductive conductor wires of the at least two winding layer groups, such that the at least two winding layer groups are fluidly coupled in parallel.

7. The electric machine according to claim 5, further comprising at least one fluidic output connection component configured to fluidly couple output-side end sections of the electrically conductive conductor wires of the at least two winding layer groups to one or more discharge chambers,
wherein the one or more discharge chambers are fluidly coupled downstream from the electrically conductive conductor wires of the at least two winding layer groups.

8. The electric machine according to claim 6, further comprising one or more supply parts, each of the one or more supply parts being situated next to at least one of the windings relative to a longitudinal direction of the electric machine,
wherein at least one of the one or more supply parts is configured as a feed part having at least one of the one or more feed chambers.

9. The electric machine according to claim 7, further comprising one or more supply parts, each of the one or more supply parts being situated next to at least one of the windings relative to a longitudinal direction of the electric machine,
wherein at least one of the one or more supply parts is configured as a discharge part having at least one of the one or more discharge chambers.

10. The electric machine according to claim 8, wherein the at least one component is configured as a rotor and the one or more supply parts have an annular shape and are concentrically situated around a rotor shaft, the rotor shaft extending along the longitudinal direction and being rotationally movably supported, and
wherein the one or more feed chambers have an annular shape and are concentrically situated around the rotor shaft.

11. The electric machine according to claim 9, wherein the at least one component is configured as a rotor and the one or more supply parts have an annular shape and are concentrically situated around a rotor shaft, the rotor shaft extending along the longitudinal direction and being rotationally movably supported, and
wherein the one or more discharge chambers have an annular shape and are concentrically situated around the rotor shaft.

12. The electric machine according to claim 8, wherein the one or more supply parts includes at least a second supply part,
wherein at least the second supply part is configured as a discharge part having at least one of the one or more discharge chambers,
wherein the at least one component is configured as a rotor and the one or more supply parts have an annular shape and are concentrically situated around a rotor shaft, the rotor shaft extending along the longitudinal direction and being rotationally movably supported, and
wherein the one or more feed chambers and the one or more discharge chambers have an annular shape and are concentrically situated around the rotor shaft.

13. The electric machine according to claim 5, further comprising one or more electrical connection components, each of the one or more electrical connection components being configured to couple end sections of the one or more electrically conductive conductor wires of two neighboring winding layer groups of one of the windings to one another, such that the two neighboring winding layer groups are electrically coupled in series.

14. The electric machine according to claim 13, wherein the end sections of the one or more electrically conductive conductor wires of pairwise neighboring winding layer groups of each winding are coupled to one another by an electrical connection component, such that all winding layer groups of each winding are successively electrically coupled in series.

15. The electric machine according to claim 6, further comprising one or more electrical connection components, each of the one or more electrical connection components being configured to couple end sections of the one or more electrically conductive conductor wires of two neighboring winding layer groups of one of the windings to one another, such that the two neighboring winding layer groups are electrically coupled in series,
wherein at least one shared connection component is provided which forms a fluidic connection component of the at least one fluidic connection components and an electrical connection component of the one or more electrical connection components.

16. The electric machine according to claim 1, wherein the component is configured as a rotor,
wherein the cooling system forms a cooling circuit through which the cooling fluid is conveyed by a conveying device,
wherein a rotor shaft of the component is rotationally movably supported, extends along a longitudinal direction of the electric machine, and includes or is adjacent to at least one feed channel and/or at least one discharge channel, the feed channel and/or the discharge channel extending, at least in sections, along the longitudinal direction of the rotor shaft, and
wherein the feed channel leads from the conveying device to the at least one electrically conductive wire having the hollow cross section, and/or the discharge channel leads to the conveying device from the at least one electrically conductive conductor wire having the hollow cross section.

17. A component for an electric machine configured as a salient pole synchronous machine, the component configured as a stator or a rotor and comprising:
a plurality of parts, at least two of the plurality of parts each having at least one tooth extending along a radial direction of the electric machine;
a winding wound around each tooth of the at least one tooth, the winding being formed from one or more electrically conductive conductor wires; and
a cooling system of the electric machine being configured to lead a cooling fluid through a hollow cross section of at least one of the one or more electrically conductive conductor wires.

18. A motor vehicle that includes an electric machine according to claim 1.

19. A method for manufacturing a component configured as a stator or a rotor for an electric machine configured as a salient pole synchronous machine, comprising:
assembling the component from a plurality of parts, at least two of the plurality of parts each having at least one tooth extending along a radial direction of the electric machine, at least one electrically conductive conductor wire for forming a winding being wound around each tooth of the at least one tooth before the component is assembled,
wherein a cooling system of the electric machine is configured to lead a cooling fluid through a hollow cross section of at least one of the at least one electrically conductive conductor wires.
